(19) United States
(12) Patent Application Publication
(10) Pub. No.: US 2018/0087644 A1
(43) Pub. Date: Mar. 29, 2018

(54) CAMSHAFT SEGMENT WITH CAMSHAFT BEARING

(71) Applicants: THYSSENKRUPP PRESTA TECCENTER AG, Eschen (LI); thyssenkrupp AG, Essen (DE)

(72) Inventor: Jürgen MEUSEL, Dittmannsdorf (DE)

(73) Assignees: THYSSENKRUPP PRESTA TECCENTER AG, Eschen (LI); thyssenkrupp AG, Essen (DE)

(21) Appl. No.: 15/573,213

(22) PCT Filed: May 4, 2016
(86) PCT No.: PCT/EP2016/060023

§ 371 Date: Nov. 10, 2017

(30) Foreign Application Priority Data
May 11, 2015 (DE) 10 2015 208 693.3

(51) Int. Cl. F16H 53/02; F01L 1/047; F16C 19/26; F16C 33/66

(52) U.S. Cl. CPC F16H 53/025; F01L 1/047; F01L 1/3442; F16C 33/6659; F01L 2001/0476; F16C 19/26

(57) ABSTRACT

A camshaft segment may include a camshaft having a shaft element and a cam element, as well as a camshaft bearing for mounting the camshaft at least in a radial or axial direction. The camshaft bearing may have an oil transfer element for transferring an oil medium to the camshaft. The camshaft may have an oil conducting element for receiving and guiding the oil medium. The camshaft bearing may have a reduction element, a material of which has a coefficient of expansion comparable to a coefficient of expansion of a material of the camshaft. In some cases, the reduction element may be a ring or a sleeve.

The present invention relates to a camshaft segment with at least one camshaft having a shaft element and a cam element, and to a camshaft bearing for mounting the camshaft at least in the radial or axial direction.

It is fundamentally known that camshafts control the gas exchange and therefore the combustion within an internal combustion engine. They are driven by the crankshaft, with the result that their rotational movement is in a defined ratio to the rotational movement with the crankshaft and therefore to the position of the pistons in the cylinders. For disruption-free operation of the camshaft, it is required, inter alia, to mount said camshaft correspondingly, in order to prevent an undesired movement in the axial and/or radial direction of the camshaft. Furthermore, it is fundamentally known that camshafts also serve to transport, for example, lubricating oil or control oil for controlling the phase shifter in the direction of a phase shifter. In a known way, the phase shifter itself serves, for example, to change the control times of the valve actuating mechanism of an internal combustion engine during operation. The phase shifter or the camshaft adjuster can be attached to the camshaft together with the cams of the camshaft and also further functional parts in such a way that said camshaft serves to feed oil to the phase shifter, in order to make a reliable and low-wear functionality of the phase shifter possible. The transfer point of said oil medium to the camshaft and, as a consequence, the phase shifter is advantageously a constituent part of the cylinder head or the cylinder head cover, in particular of bearing elements which are connected thereto for mounting the camshaft in the cylinder head cover. The cylinder head cover is manufactured in a known way from aluminum material or is a cast aluminum element. In a known way, there are considerable differences in the coefficient of expansion in the case of a cast aluminum element in comparison with the camshaft or the transfer element for transferring the oil, which are manufactured, in particular, from an iron material. As a consequence, a great gap change of the gap which is formed between the bearing and the camshaft occurs within a temperature range of, for example, from −40° C. to +140° C. It is conceivable during operation of the engine that the gap is enlarged in such a way that the functionality of the phase shifter is influenced negatively. In particular, the volumetric flow which is introduced at the transfer point and also the oil pressure drop significantly. Although it would be conceivable to manufacture components and systems of this type from cast iron in a manner which corresponds to the camshaft material, in order to prevent the occurrence of different coefficients of expansion of a very wide variety of materials, cast iron components have the disadvantage, in particular, that they have an excessively high weight and, as a consequence, counter the aspiration of the automotive industry toward vehicle components and vehicles of reduced weight. For this reason, components made from aluminum or cast aluminum are mainly used.

It is therefore the object of the present invention to at least partially eliminate the above-described disadvantages in the case of a camshaft, in particular in the case of a camshaft segment. In particular, it is the object of the present invention to provide a camshaft segment, in the case of which a reliable oil transfer is made possible from the camshaft bearing or the cylinder head cover to the phase shifter via the camshaft, even during overheating of the internal combustion engine during operation.

The above object is achieved by way of a camshaft segment having the features of claim 1. Further features and details of the invention result from the subclaims, the description and the drawings.

The camshaft segment according to the invention has at least one camshaft having a shaft element and a cam element, and at least one camshaft bearing for mounting the camshaft at least in the radial or axial direction, the camshaft bearing having at least one oil transfer element for transferring an oil medium, in particular a flowable oil medium to the camshaft, and the camshaft having at least one oil conducting element for receiving and guiding the oil medium at least in the direction of an oil path. According to the invention, the camshaft bearing has a reduction element, the material of which has a coefficient of expansion comparable to the coefficient of expansion of the material of the camshaft. As a consequence, the camshaft segment is advantageously a system consisting of a camshaft and its camshaft bearing. The camshaft particularly advantageously has two camshaft bearings which mounts the camshaft at its respective ends correspondingly in the radial or else axial direction or else in the radial and axial direction. A radial bearing is advantageously used as camshaft bearing, which radial bearing mounts the shaft element as rotary bearing and, as a consequence, prevents two possibilities of movement in the radial direction of the circular cross section of the shaft element. Furthermore, it is conceivable that the camshaft bearing is an axial bearing, or one of the camshaft bearings is a radial bearing and the other one of the camshaft bearings is an axial bearing. The shaft element advantageously serves to transport the oil medium, from the camshaft bearing, in particular a camshaft bearing point to a phase shifter which can be connected to the camshaft. The flowable oil medium is, for example, a lubricating oil or a control oil for controlling the phase shifter or adjusting element. The shaft element is, for example, a hollow shaft which can also be called an outer shaft. It is thus conceivable that an inner shaft which is advantageously configured as a solid shaft extends coaxially within the hollow shaft. The at least one cam element is advantageously connected fixedly to the shaft element so as to rotate with it, and extends away to the outside, starting from the outer surface of the shaft element. If a shaft element is present as an outer shaft or a hollow shaft with a correspondingly arranged inner shaft, it is also conceivable that the camshaft has at least two cam elements, in particular a fixed cam element and an adjustable cam element. Here, one of the cam elements is connected fixedly to the outer shaft so as to rotate with it, whereas the other one of the cam elements is connected fixedly to the inner shaft so as to rotate with it. It is conceivable here that a corresponding fixing element which advantageously connects the adjustable cam element to the inner shaft extends through an opening of the outer shaft to the inner shaft, starting from the adjustable cam element. Here, the two cam elements, that is to say the adjustable cam element and the fixed cam element, are advantageously arranged on the outer surface of the shaft element, in particular the outer shaft, it being possible for the adjustable cam element to be moved relative to the fixed cam element.

Within the context of the invention, the coefficient of expansion is understood to mean, in particular, the coefficient of thermal expansion or the thermal expansion coefficient. This is a characteristic value which, as is known, describes the behavior of a material with regard to the change of its dimensions during a temperature change. Here, said thermal expansion is dependent, in particular, on the material, such that, as a result, the coefficient of thermal expansion is a material-specific constant. The camshaft bearing itself is advantageously a constituent part of the cylinder head or the cylinder head cover, which is manufactured at least partially and advantageously completely from an aluminum material, in particular from a cast aluminum, in order to advantageously reduce the weight of the entire camshaft segment. On account of the arrangement of the reduction element in the region of the camshaft bearing, the different expansion factors between the camshaft bearing and that region of the oil transfer on the camshaft or the rotary oil transfer region which is advantageously manufactured from an iron material are reduced as a consequence. As a result, an increase in the functionality of the camshaft segment, in particular of the camshaft and also the phase shifter, is possible on account of a reduction of the wear of the phase shifter, in particular, at the critical operating points at high temperature and a low oil pressure and, as a consequence, impaired control times during the operation of the internal combustion engine.

Furthermore, it is conceivable that the reduction element is a ring element or a sleeve element. Here, the ring element or the sleeve element can be inherently closed or else can have an opening. The reduction element advantageously extends at least partially in the circumferential direction around the shaft element and encloses the latter at least in sections.

Furthermore, it is conceivable that the reduction element is introduced into the material of the camshaft bearing in such a way that the reduction element is encapsulated completely by the material of the camshaft bearing. It is conceivable here that the reduction element is cast into the camshaft bearing during the production process of said camshaft bearing. This means that, during the production process of the camshaft bearing, the reduction element is encapsulated by means of the material of the camshaft bearing and, in particular, by way of the cast aluminum material. Furthermore, it is also conceivable, however, that the camshaft bearing has a cutout in such a way that the reduction element is pressed into the camshaft bearing after the production of said camshaft bearing and, as a consequence, after the casting process of said camshaft bearing. In the last-mentioned case, the reduction element is not encapsulated or surrounded completely by the material of the camshaft bearing.

It is possible, furthermore, that the reduction element is introduced into the material of the camshaft bearing in such a way that an outer surface of the reduction element is surrounded by the material of the camshaft bearing, an inner surface of the reduction element serving as a running face of the camshaft bearing. This means that, in particular, said inner surface of said reduction element does not make contact with the material of the camshaft bearing and is advantageously at least partially in contact with the shaft element, in particular the outer surface of the shaft element. Accordingly, the inner surface advantageously serves as an inner ring of the camshaft bearing itself, which inner surface serves as a running face with respect to the camshaft and, as a consequence, is in direct contact with the camshaft or the shaft element of the camshaft. Furthermore, it is conceivable that the reduction element has projections in the region of one or both of its distal ends, as a result of which an arrangement of the camshaft bearing with the reduction element or a connection of the camshaft bearing to the reduction element is advantageously improved, in particular by a section of the camshaft bearing being pressed into the region of the recess/recesses of the reduction element which is/are formed by way of the projections, in order, as a consequence, to make a press-fit connection possible between the camshaft bearing, in particular the region of the oil transfer of the camshaft bearing, and the reduction element.

Furthermore, it is conceivable that the reduction element consists at least partially of an iron material. The reduction element advantageously consists completely of an iron material or of a material of comparable quality. Accordingly, the reduction element has a lower coefficient of thermal expansion than, in particular, the camshaft bearing and advantageously that region of the oil transfer of the camshaft bearing or the cylinder head cover which is produced, for example, from an iron material or a material of comparable quality. Accordingly, a smaller thermal deformation of the reduction element and, in particular, of the entire camshaft bearing or the region of the oil transfer point of the camshaft bearing advantageously takes place during the operation of the internal combustion engine and during the heating of the corresponding regions.

Furthermore, it is possible that the reduction element is coated at least in sections. Here, the coating is advantageously applied in the region of the running face or contact face with respect to the camshaft, in particular with respect to the shaft element of the camshaft. Here, the friction between the reduction element and the camshaft is advantageously avoided. As a result, the wear of the surfaces of the reduction element or the camshaft to be mounted is advantageously reduced.

It is possible within the scope of the invention that the oil conducting element has a shaft element through opening which, starting from an outer shaft element surface, extends to an inner shaft element surface. This advantageously ensures that the oil medium can be introduced, starting from the oil transfer point of the camshaft bearing, into the inner region of the shaft element, in order to make a reliable transport of the oil medium to the phase shifter via the shaft element possible and, as a consequence, reliable operation of at least the camshaft segment and accordingly the internal combustion engine or the phase shifter.

Furthermore, it is conceivable that the camshaft additionally has an end piece which is arranged in such a way that the shaft element can be connected to a phase shifter for variable valve control. It is possible here that the end piece extends at least in sections into the shaft element. To this end, the shaft element advantageously has at least one corresponding cutout, or is a hollow shaft, into the cavity of which or into the through opening of which the end piece extends. The phase shifter which can also be called a camshaft adjuster advantageously serves to change the control times of the valve actuating mechanism of the internal combustion engine during the operation. By means of the phase shifter, the rotary angle or the valve stroke of the camshaft can advantageously be changed by way of, for example, an adjustment of the inner shaft relative to the outer shaft and, as a consequence, the cam element which is connected fixedly to the inner shaft so as to rotate with it relative to the cam element which is connected fixedly to the outer shaft so as to rotate with it.

Furthermore, it is conceivable that the oil conducting element has an end piece through opening which extends through the end piece from an outer end piece surface to an inner end piece surface. The oil transfer element of the camshaft bearing is advantageously arranged flush with respect to the shaft element through opening and/or with respect to the end piece through opening in such a way that an oil medium can be introduced, starting from the camshaft bearing, in particular the oil transfer point or the oil transfer region of the camshaft bearing, via the shaft element and/or the end piece into the inner region of the shaft element, in order to make reliable conducting or guidance of the oil medium to the phase shifter possible. This means that, depending on the arrangement of the end piece and the shaft element, it is also conceivable that the shaft element through opening is arranged flush with respect to the end piece through opening.

It is additionally conceivable that the oil conducting element additionally has an oil conducting sleeve for configuring an oil path, advantageously a plurality of oil paths. The oil conducting sleeve advantageously extends coaxially within the shaft element and, in particular, within a cutout or the cavity of the shaft element. By means of the oil conducting sleeve, a reliable transport of the oil medium within the shaft element in the direction of the phase shifter is advantageously made possible. The phase shifter is advantageously arranged at a distal end of the shaft element or the camshaft.

In the following text, embodiments of a camshaft segment according to the invention will be described in greater detail using drawings, in which, in each case diagrammatically:

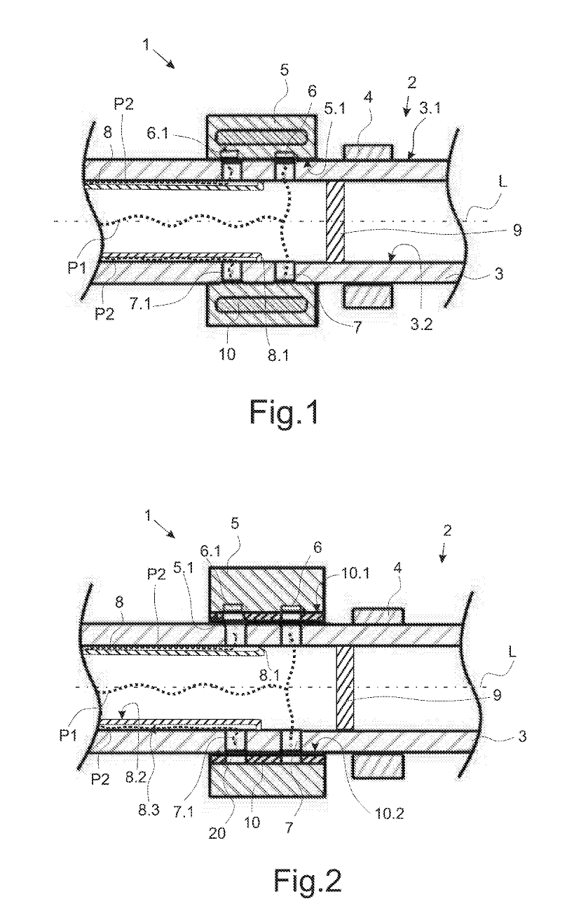

FIG. 1 shows a lateral sectional illustration of a detail of one embodiment of the camshaft segment according to the invention,

FIG. 2 shows a lateral sectional illustration of a detail of a further, in particular second, embodiment of the camshaft segment according to the invention,

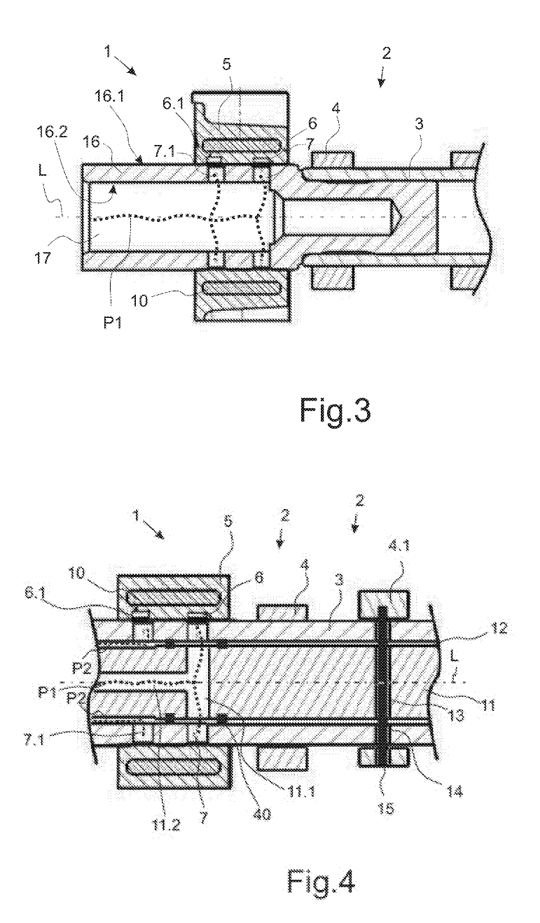

FIG. 3 shows a lateral sectional illustration of a detail of a further, in particular third, embodiment of the camshaft segment according to the invention,

FIG. 4 shows a lateral sectional illustration of a detail of a further, in particular fourth, embodiment of the camshaft segment according to the invention, and

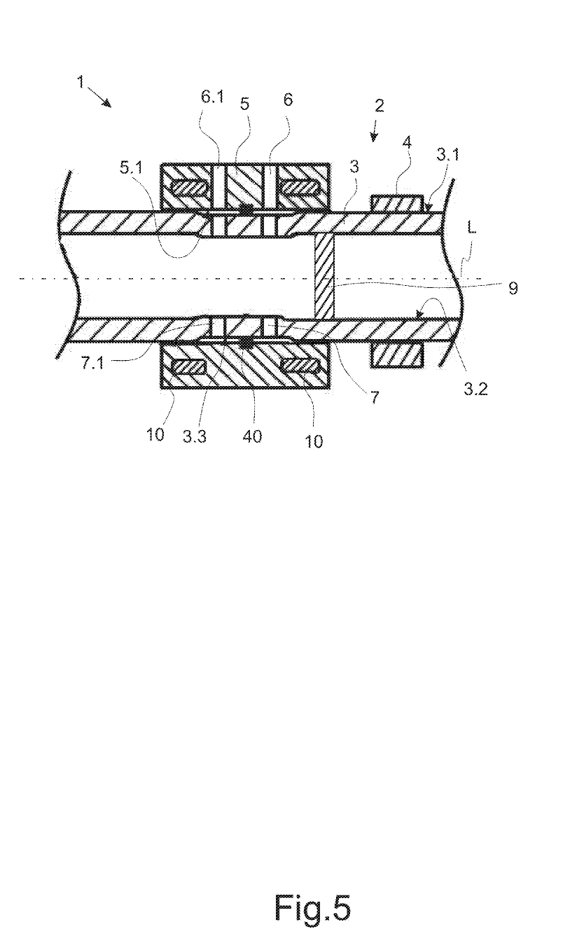

FIG. 5 shows a lateral sectional illustration of a detail of a further, in particular fifth, embodiment of the camshaft segment according to the invention.

Elements with the same function and method of operation are provided in each case with the same designations in FIGS. 1 to 5.

FIG. 1 diagrammatically shows a lateral sectional illustration of a detail of one embodiment, in particular a first embodiment of the camshaft segment 1 according to the invention. The camshaft segment 1 has, inter alia, a camshaft 2 having a shaft element 3, and a cam element 4 which is connected fixedly to the shaft element 3 so as to rotate with it. The shaft element 3 is advantageously a hollow shaft or has at least one cavity which extends at least in sections in the axial direction of the shaft element 3, that is to say along the longitudinal axis L of the shaft element 3. A camshaft bearing 5 serves to mount the camshaft 2, in particular the shaft element 3 of the camshaft 2. The camshaft bearing 5 is advantageously a constituent part of the camshaft segment 1 and has a reduction element 10 which is encapsulated completely by the material of the camshaft bearing 5 and, in accordance with the refinement of the camshaft bearing 5, extends at least in sections in the circumferential direction around the shaft segment 3.

The reduction element 10 which is shown in FIG. 1 is formed, for example, in the shape of a sleeve. The camshaft bearing 5, in particular the oil transfer region (shown in FIG. 1) of the camshaft bearing 5, is at least partially and advantageously completely formed from an aluminum material. The reduction element 10 is advantageously formed from an iron material. The reduction element 10 advantageously has a material of comparable quality with respect to the material of the camshaft segment 1, in particular the shaft element 3. The camshaft bearing 5 or the oil transfer region of the camshaft bearing 5 has at least one and advantageously two oil transfer elements 6 and 6.1 which are configured in the region of the inner surface 5.1 of the camshaft bearing 5, in particular the running face of the camshaft bearing 5. As a consequence, in the region of the transfer element 6, 6.1, an oil medium (not shown here) is transferred, starting from the camshaft bearing 5, to the camshaft 2, in particular the shaft element 3 of the camshaft 2. For this purpose, the shaft element 3 of the camshaft 2 has at least one and advantageously two oil conducting elements 7 or 7.1. Here, the number of oil conducting elements 7, 7.1 is advantageously aligned with the number of oil transfer elements 6, 6.1. Accordingly, it is also conceivable that the camshaft bearing 5 has three or more oil transfer elements 6 and 6.1, and the shaft element 3 has three or more oil conducting elements 7 and 7.1. As shown in the embodiment of FIG. 1, the oil conducting element 7, 7.1 is advantageously configured in the shape of a shaft element through opening which, starting from an outer surface 3.1 of the shaft element 3, extends through a wall of the shaft element 3 to an inner surface 3.2 of the shaft element. The oil conducting element 7, 7.1 advantageously extends completely through the shaft element 3 in this way, with the result that it penetrates the shaft segment 3 completely as viewed in the radial direction. This means that the oil conducting element 7, 7.1 penetrates the circumferential wall of the shaft element 3 in two regions of said circumferential wall, in such a way that an oil medium is transported or guided, starting from an outer surface 3.1, to an inner surface 3.2 of the shaft element 3. This facilitates an introduction of the oil medium into the inner region of the shaft element 3, even in the case of a shaft element 3 which is rotating about its central longitudinal axis L. Here, the position of the oil transfer element 6 and 6.1 is advantageously configured so as to be flush with the position of the oil conducting element 7 and 7.1 in such a way that a transfer of the oil medium can take place, starting from the camshaft bearing 5, in particular the oil transfer element 6 and 6.1 of the camshaft bearing 5, into the region of the oil conducting element 7 and 7.1. In particular, the arrangement (as viewed in the axial direction) of the oil transfer element 6 and 6.1 and the oil conducting element 7 and 7.1 is adapted to one another, in order to ensure fault-free oil medium transfer. The oil conducting element 7 and 7.1 advantageously serves to guide received oil medium into the inner region of the shaft element 3, from where it is transported further in the direction of a phase shifter (not shown here).

Furthermore, it is possible as shown in FIG. 1 that the oil conducting element 7, 7.1 additionally has an oil conducting sleeve which is labeled, in particular, by the designation 8. The oil conducting sleeve 8 extends substantially within the shaft element 3, in particular coaxially with respect to the shaft element 3. The oil conducting sleeve 8 advantageously has a collar 8.1 which extends substantially in the radial direction, starting from a distal end of the oil conducting sleeve 8, in the direction of the wall of the shaft element 3, in particular to the inner surface 3.2 of the shaft element 3. The collar 8.1 particularly advantageously makes contact with the inner surface 3.2 of the shaft element 3. As a result, a transport of an oil medium is advantageously assisted in a defined direction and is avoided in an undesired direction. As a consequence, the collar 8.1 advantageously serves as a limiting element or sealing element. A transport of the received oil medium in the direction of the phase shifter (not shown) by means of the oil conducting sleeve 8 is conceivable. The oil conducting sleeve 8 makes it possible to configure two oil paths P1 and P2 which are different from one another. The first oil path P1 extends, starting from the first oil conducting element 7, into the interior of the shaft element 3 (substantially in the radial direction) and, further in the axial direction, through the opening of the oil conducting sleeve 8 in the direction of the phase shifter (not shown here). Accordingly, the oil medium which flows along the first oil path P1 makes contact at least in sections with an inner surface 8.2 of the oil conducting sleeve 8. The second oil path P2 in the direction of the phase shifter runs substantially, starting from the second oil conducting element 7.1, along the outer wall or outer surface 8.3 of the oil conducting sleeve 8, in particular between the oil conducting sleeve 8 and the inner surface 3.2 of the shaft element 3. The first oil path P1 and the second oil path P2 are separated from one another spatially by means of the collar 8.1. It is possible, furthermore, that the camshaft segment 1 has a limiting element 9 which is introduced within the camshaft 2, in particular within the shaft element 3 of the camshaft 2. The limiting element 9 is advantageously formed in the shape of a plug and serves, for example, to prevent an outflow of the oil medium in an undesired direction or into an undesired region of the camshaft 2 or the camshaft element 3.

FIG. 2 diagrammatically shows a lateral sectional illustration of a detail of a further, in particular second, embodiment of the camshaft segment 1 according to the invention.

The camshaft segment 1 which is shown in FIG. 2 differs from that embodiment of the camshaft segment 1 which is shown in FIG. 1 in that the reduction element 10 is not enclosed or encapsulated completely by the material of the camshaft bearing 5, in particular its oil transfer region. Rather, the reduction element 10 which is shown in the embodiment of FIG. 2 is arranged on the inner surface 5.1 of the camshaft bearing 5 in such a way that the reduction element 10 makes contact with the material of the camshaft bearing 5 merely on its outer surface 10.1. Accordingly, the inner surface 10.2 of the reduction element 10 does not make contact with the material of the camshaft bearing 5, that is to say is exposed, and advantageously serves as a running face of the camshaft bearing 5, which running face is in contact at least temporarily with the camshaft 2, in particular the shaft element 3 of the camshaft 2.

In that refinement of the camshaft segment 1 which is shown in FIG. 2, as a consequence, the reduction element 10 is not enclosed in the camshaft bearing during, for example, the production process of said camshaft bearing, as shown in the embodiment in FIG. 1, but rather the reduction element 10 is pressed or pressed together with the camshaft bearing which has already been produced. Accordingly, the camshaft bearing 5 and the reduction element 10 advantageously form a press-fit connection. It is also conceivable here that the reduction element 10 has, for example, projections or holding regions, in order to clamp in corresponding regions of the camshaft bearing 10. In order to advantageously make a disruption-free flow of the oil medium possible, starting from the camshaft bearing 5, into the inner region of the shaft element 3 of the camshaft 2, it is accordingly necessary that the reduction element 10 has corresponding through openings 20. Said through openings 20 advantageously extend, starting from the outer surface 10.1, to the inner surface 10.2 of the reduction element 10 through the wall of the latter. The camshaft bearing 5, the reduction element 10 and the shaft element 3 of the camshaft 2 are advantageously arranged with respect to one another in such a way that the transfer elements 6, the through openings 20 and the oil conducting elements 7 are flush with one another at least temporarily during a rotation of the shaft element 3 about its central longitudinal axis L, in such a way that a reliable transfer and forwarding of the oil medium is made possible, starting from the camshaft bearing 5, into the inner region of the shaft element 3 of the camshaft 2. As has already been described in respect of the embodiment of FIG. 1, at least two oil paths P1 and P2 which are separated from one another spatially are also formed in the embodiment according to FIG. 2. In this regard, reference is made to the full scope of the above description with respect to FIG. 1.

FIG. 3 shows a lateral sectional illustration of a detail of a further, in particular third, embodiment of the camshaft segment 1 according to the invention. In contrast to those embodiments of the camshaft segment 1 according to the invention which are shown in FIGS. 1 and 2, that embodiment of the camshaft segment 1 according to the invention which is shown in FIG. 3 additionally has an end piece 16 which extends at least in sections into an inner region of the shaft element 3 of the camshaft 2 and is arranged, in particular, in a distal region of the shaft element 3. The end piece 16 is advantageously a constituent part of the camshaft 2. The camshaft 2 is advantageously mounted via the end piece 16, with the result that the camshaft bearing 5 is arranged in the region of the end piece 16. As has already been shown in FIG. 1, the reduction element 10 is advantageously enclosed or encapsulated completely by the material of the camshaft bearing 5, in particular of the oil transfer region of the camshaft bearing 5. In a difference from those embodiments of the camshaft segment 1 which are shown in FIGS. 1 and 2, it is not the shaft element 3, but rather the end piece 16 which has corresponding oil conducting elements 7 and 7.1 which advantageously extend in the form of an end piece through opening, starting from an outer surface 16.1, to an inner surface 16.2 of the end piece 16 through a wall of the end piece 16. Here, the oil conducting elements 7 and 7.1 which are made in the end piece 16 are advantageously arranged flush with respect to the oil transfer elements 6 and 6.1 of the camshaft bearing 5, with the result that a disruption-free transfer of the oil medium can take place, starting from the camshaft bearing 5, via the oil transfer elements 6, 6.1 and oil conducting elements 7, 7.1 into the inner region, in particular the cavity 17 of the end piece 16. The two oil conducting elements 7 and 7.1 advantageously serve to configure a single common oil path 1 which extends within the cavity 17. The cavity 17 also advantageously serves to receive a central bolt (not shown here).

FIG. 4 diagrammatically shows a lateral sectional illustration of a detail of a further, in particular fourth, embodiment of the camshaft segment 1 according to the invention. In a difference from those embodiments of the camshaft segment 1 according to the invention which are shown in FIGS. 1 to 3, the camshaft element 1 which is shown in FIG. 4 has a camshaft 2 consisting of a shaft element 3 which is, in particular, an outer shaft, advantageously a hollow shaft, and of an inner shaft 11. A cam element 4 which is also called, for example, a fixed cam element 4 is connected fixedly to the outer shaft 3 so as to rotate with it, whereas a further camshaft element 4.1 which can be called, for example, an adjustable cam element 4.1 is connected fixedly to the inner shaft 11 so as to rotate with it via a corresponding connecting means 15. The connecting means 15 advantageously extends, starting from the cam element 4.1, through an outer shaft bore 14 into the region of the inner shaft 11. The connecting means 15 advantageously extends completely through the inner shaft 11, in particular through an inner shaft bore 13 of the inner shaft 11. During a rotation of the inner shaft 11 relative to the outer shaft 3 of the camshaft 2, as a consequence, a rotation of the cam element 4 relative to the cam element 4.1 also takes place about the corresponding camshaft longitudinal axis L. The rotation of the inner shaft 11 relative to the outer shaft 3 is advantageously made possible by way of a phase shifter (not shown here). It is conceivable here that the inner shaft 11 or the outer shaft 3, or the inner shaft 11 and the outer shaft 3, is/are rotated or moved about the longitudinal axis L. In order to make a simple and reliable adjustment of the inner shaft 11 relative to the outer shaft 3 possible, the inner shaft 11 extends coaxially with respect to the outer shaft 3 at least in sections through the latter, a gap 12 existing between the inner shaft 11 and the outer shaft 3, in order to avoid a friction between the inner shaft 11 and the outer shaft 3, in particular an outer surface of the inner shaft 11 and an inner surface of the outer shaft 3. A first oil path P1 is advantageously formed by means of the oil conducting element 7, in which first oil path P1 the oil medium is received, starting from the oil conducting element 7, by the oil transfer element 6 and is introduced into a cavity, in particular a bore of the inner shaft 11. To this end, the inner shaft 11 has a bore 11.1 which extends substantially in the radial direction and opens at least in sections into a bore 11.2 which extends substantially in the axial direction. The bore which extends in the radial direction, namely the radial bore 11.1, makes an introduction of the oil medium possible, starting from the oil conducting element 7, into the interior of the inner shaft 11. The bore which extends in the axial direction, namely the axial bore 11.2, makes a transfer of the oil medium which is received into the inner shaft 11 possible, and a forwarding of said oil medium to a phase shifter (not shown here). A first oil path P1 is formed as a result. In order to avoid an inflow of the oil medium into the gap 12 and, as a consequence, also in the direction of a second oil path P2 which is formed by means of the second oil conducting element 7.1, seals 40 are arranged in the region of the gap 12 in such a way that the oil medium which is transferred by the (first) oil transfer element 6 to the shaft element 3 is transported merely along a defined first oil path P1. The second oil path P2 is advantageously formed by means of a second oil conducting element 7.1 which receives the oil medium from a second oil transfer element 6.2 and transports or guides it within a section of the gap, that is to say in a region between the inner shaft 11 and the outer shaft 3, in particular an outer surface of the inner shaft 11 and an inner surface 3.2 of the outer shaft 3.

FIG. 5 shows a lateral sectional illustration of a detail of a further, in particular fifth, embodiment of a camshaft segment 1 according to the invention which differs from the embodiment which is shown in FIG. 1, for example, by way of the arrangement of two reduction elements 10 which are arranged spaced apart from one another. Said reduction elements 10 are advantageously configured in the shape of a ring and, as viewed in the axial direction, are arranged spaced apart from one another in such a way that at least one oil transfer element 6, advantageously two oil transfer elements 6 and 6.1, extends/extend between said reduction elements 10 in the direction of the shaft element 3. The oil transfer elements 6 and 6.1 are advantageously configured in the shape of a bore, in particular a through bore. Furthermore, the shaft element 3 has a constriction 3.3 of the wall. Said constriction 3.3 extends, as viewed in the axial direction, at least in sections along the shaft element wall in such a way that the outer surface 3.1 of the shaft element 3 has a depression, the inner surface 3.2 of the shaft element 3 having an elevation. A constriction 3.3 of this type of the shaft element 3 advantageously serves to configure a defined spacing between the outer surface 3.1 of the shaft element 3 and an inner surface 5.1 of the camshaft bearing 5. Accordingly, the constriction 3.3 is advantageously also configured in that region of the shaft element 3, in which the camshaft bearing 5 makes contact at least in sections with the camshaft 2, in particular the shaft element 3 of the camshaft 2, in order to make a bearing possible. A constriction 3.3 which is configured in this way advantageously serves to facilitate, or at least to provide, a play in the region of the camshaft bearing 5 between the latter and the camshaft 2. In addition, the constriction 3.3 facilitates the flow of the oil medium which is to be transferred to the shaft element 3 into the sections of the oil conducting elements 7 and 7.1. This means that, as a consequence, the oil medium flows together in the region of the constriction 3.3, and undesired flow along the outer surface 3.1 of the shaft element 3 is avoided.

Furthermore, it is conceivable to arrange a sealing element or a seal 40 between the shaft element 3 and the camshaft bearing 5, by means of which sealing element or seal 40, as shown in FIG. 5, a spatial separation is made possible between the oil medium flows which are to be introduced into the oil conducting elements 7 and 7.1.

1.-10. (canceled)

11. A camshaft segment comprising:
a camshaft having a shaft element, a cam element, and an oil conducting element, wherein the oil conducting element receives and guides an oil medium at least in a direction of an oil path; and
a camshaft bearing for mounting the camshaft at least in a radial direction or an axial direction, wherein the camshaft bearing comprises
an oil transfer element for transferring the oil medium to the camshaft, and
a reduction element.

12. The camshaft segment of claim 11 wherein the reduction element is comprised of a material that has a coefficient of expansion that is within ±2.5% of a coefficient of expansion of a material of the camshaft.

13. The camshaft segment of claim 11 wherein the reduction element is comprised of a material that has a coefficient of expansion that is within ±5% of a coefficient of expansion of a material of the camshaft.

14. The camshaft segment of claim 11 wherein the reduction element is comprised of a material that has a coefficient of expansion that is within ±10% of a coefficient of expansion of a material of the camshaft.

15. The camshaft segment of claim 11 wherein the reduction element is comprised of a material that has a coefficient of expansion that is equivalent to a coefficient of expansion of a material of the camshaft.

16. The camshaft segment of claim 11 wherein the reduction element is comprised of a material that has a coefficient of expansion that is generally equivalent to a coefficient of expansion of a material of the camshaft.

17. The camshaft segment of claim 11 wherein the reduction element is comprised of a material that has a coefficient of expansion comparable to a coefficient of expansion of a material of the camshaft.

18. The camshaft segment of claim 17 wherein the reduction element is a ring or a sleeve.

19. The camshaft segment of claim 17 wherein the reduction element is disposed in a material of the camshaft bearing such that the reduction element is encapsulated completely by the material of the camshaft bearing.

20. The camshaft segment of claim 17 wherein the reduction element is disposed in a material of the camshaft bearing such that an outer surface of the reduction element is surrounded by the material of the camshaft bearing, wherein an inner surface of the reduction element serves as a running face of the camshaft bearing.

21. The camshaft segment of claim 17 wherein the reduction element comprises an iron material.

22. The camshaft segment of claim 17 wherein the reduction element is coated at least in sections.

23. The camshaft segment of claim 17 wherein the oil conducting element includes a shaft element-through opening, which extends from an outer surface of the shaft element to an inner surface of the shaft element.

24. The camshaft segment of claim 17 wherein the camshaft further comprises an end piece that is disposed such that the shaft element is connectable to a phase shifter for variable valve control.

25. The camshaft segment of claim 24 wherein the oil conducting element comprises an end piece-through bore, which extends from an outer surface of the end piece to an inner surface of the end piece.

26. The camshaft segment of claim 17 wherein the oil path is a first oil path, wherein the oil conducting element comprises an oil conducting sleeve for configuring a second oil path.
